(19) United States
(12) Patent Application Publication
(10) Pub. No.: US 2025/0176514 A1
(43) Pub. Date: Jun. 5, 2025

(54) Feather Tailed Stand-Up Jig

(71) Applicants: Steven Matthew Zula, Kitchener (CA); Wesley Thomas Ruppenthal, Kitchener (CA)

(72) Inventors: Steven Matthew Zula, Kitchener (CA); Wesley Thomas Ruppenthal, Kitchener (CA)

(21) Appl. No.: 18/527,862

(22) Filed: Dec. 4, 2023

(51) Int. Cl. A01K 85/00

(52) U.S. Cl. CPC A01K 85/1833; A01K 85/1821

(57) ABSTRACT

A feather tailed stand-up jig is provided. The feather tailed stand-up jig includes a weighted body having a hook securely attached to a proximal end of the weighted body, wherein the hook is oriented in an upward-facing position when the weighted body is resting on a bottom of a body of water, such that the barb of the hook is positioned above the bottom. The weighted body includes a flat lower surface to support the jig in an upright orientation. An eyelet extends from a front side of the weighted body and can receive a fishing line therethrough. A feathered tail extends from a rear side of the weighted body forming a rearmost side of the feather tailed stand-up jig. As the fishing jig is dragged along the bottom of the body of water, the feathered tail moves to mimic the appearance of aquatic organisms.

### BACKGROUND OF THE INVENTION

The present invention relates to fishing jigs. The present invention provides a feather tailed stand-up jig having a feathered tail extending from a rear side of the weighted body forming a rearmost side of the feather tailed stand-up jig.

Fishing has been a popular recreational activity and a means of sustenance for centuries, with various fishing techniques and equipment continuously evolving to improve the efficiency of catching fish. One such essential tool in the angler's arsenal is the fishing jig, a versatile and effective lure used to attract and entice fish. Traditional fishing jigs come in various forms and shapes, designed to imitate the appearance and movements of aquatic organisms, such as baitfish, insects, or other prey items commonly sought by fish. These jigs are typically composed of a weighted body, often featuring a hook at the front, to which bait or soft plastics can be attached. The design of these jigs is aimed at mimicking the behavior and appearance of prey species, enticing fish to strike and facilitating the hooking of the fish when they do.

Despite the utility of traditional fishing jigs, they exhibit certain deficiencies that can hinder their effectiveness in catching fish. Most notably, conventional jigs tend to lie flat on the bottom when at rest, which can obscure the visibility of the bait and make it less accessible to fish foraging near the substrate. Fish may overlook or miss such jigs as they are not prominently displayed. Furthermore, many traditional jigs are limited in their ability to replicate the lifelike movements and appearances of aquatic organisms when at rest, especially those that exhibit vertical or semi-vertical orientations in their natural environment. These deficiencies can lead to missed opportunities and reduced catch rates for anglers.

The present invention is equipped with a feathered tail that forms the rearmost end of the jig. By incorporating a feathered tail, this design leverages the principles of biomimicry to enhance the lure's lifelike appearance and movement. The feathered tail effectively mimics the appearance of aquatic organisms, such as baitfish or invertebrates, while still allowing bait to be attached to the hook at the jig's front end. The feathered tail, combined with the stand-up feature, positions the bait and hook above the substrate, significantly improving their visibility to fish and making them more accessible to foraging predators.

Furthermore, the feathered tail adds an additional layer of realism to the lure's presentation. The subtle movement of the feathers in the water's current or with the angler's retrieval action creates a more convincing illusion of a living organism, making it even more enticing to fish. The fishing jig with a feathered tail addresses the deficiencies of traditional jigs by enhancing their appearance, movement, and accessibility to fish. The position of the feathers and overall design of the jig ultimately contribute to the lure's effectiveness, making it a valuable tool for anglers seeking to increase their success in catching a variety of fish species.

In light of the devices disclosed in the known art, it is submitted that the present invention substantially diverges in design elements and methods from the known art and consequently it is clear that there is a need in the art for an improvement for a stand-up fishing jig. In this regard the instant invention substantially fulfills these needs.

### SUMMARY OF THE INVENTION

In view of the foregoing disadvantages inherent in the known types of stand-up fishing jigs now present in the known art, the present invention provides a feather tailed stand-up jig having a feathered tail forming the rearmost side thereof.

It is an objective of the present invention to provide a feather tailed stand-up jig comprising a weighted body having a proximal end and a distal end, wherein a hook is securely attached to the proximal end of the weighted body. The hook is oriented in an upward-facing position when the weighted body is resting on a bottom of a body of water, such that the barb of the hook is positioned above the bottom. The weighted body includes a flat lower surface to support the jig in an upright orientation. An eyelet extends from a front side of the weighted body and can receive a fishing line therethrough. A feathered tail extends from a rear side of the weighted body forming a rearmost side of the feather tailed stand-up jig.

It is an objective of the present invention to provide a feather tailed stand-up jig that maintains an upright position on the bottom of a body of water, ensuring that the bait and hook are prominently displayed above the substrate. This design enhances the lure's visibility to fish, increasing the likelihood of attracting their attention and enticing them to strike.

It is an objective of the present invention to offer a fishing jig with a feathered tail that closely mimics the appearance and movement of aquatic organisms while still allowing bait to be securely attached to the hook. The feathered tail, combined with the stand-up feature, provides a more convincing illusion of a living organism, making the lure highly enticing to a wide range of fish species.

It is an objective of the present invention to overcome the deficiencies of traditional fishing jigs by providing a lure that effectively replicates the lifelike behavior and appearance of aquatic organisms, especially those that maintain vertical or semi-vertical orientations in their natural habitat. This innovation significantly enhances the angler's ability to catch fish and increases the overall efficiency and success of fishing endeavors.

It is therefore an object of the present invention to provide a new and improved feather tailed stand-up jig that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the feather tailed stand-up jig.

FIG. 2 shows a perspective view of an alternate embodiment of the feather tailed stand-up jig.

FIG. 3 shows a perspective view of an embodiment of the feather tailed stand-up jig in use.

### DETAILED DESCRIPTION OF THE INVENTION

Reference is made herein to the attached drawings. For the purposes of presenting a brief and clear description of the present invention, the preferred embodiment will be discussed as used for fishing and attracting fish using a feather tailed stand-up jig with a feathered tail. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

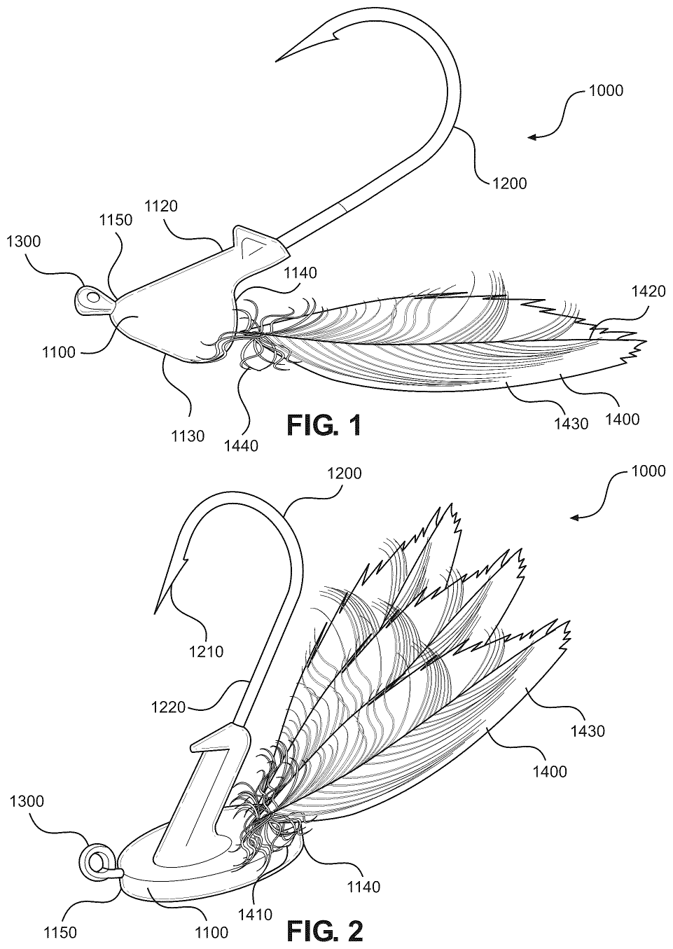

Referring now to FIGS. 1 and 2, there are shown perspective views of multiple embodiments of the feather tailed stand-up jig. In the illustrated embodiment, the feather tailed stand-up jig 1000 comprises a weighted body 1100 having a proximal end 1120 and a distal end 1130. In the illustrated embodiment, the weighted body 1100 is elongated and comprises a substantially flat bottom surface to support the feather tailed stand-up jig 1000 in an upright orientation. In some embodiments, the weighted body 1100 is composed of a metal, such as lead, tungsten, or the like. In some embodiments, an upper surface of the weighted body is substantially flat, wherein other embodiments the upper surface thereof is rounded or tapers towards the proximal end thereof.

In the shown embodiment, weighted body 1100 comprises a base having the flat bottom surface that extends to an edge, wherein the flat bottom surface is entirely flat. The feather tailed stand-up jig 1000 further comprises a hook 1200 securely attached to the proximal end 1200 of the weighted body 1100. The hook 1200 comprises a barb 1210 and a shank 1220, wherein the hook 1200 is oriented in an upward-facing position when the weighted body 1100 is resting on a bottom surface of a body of water, such that the barb of the hook is positioned above the bottom. In the illustrated embodiment, the shank 1220 is slanted and extends towards a rear side 1140 of the weighted body 1100 when the weighted body 1100 rests flat against a surface. In the illustrated embodiment, the hook 1200 extends from a central area of the weighted body 1100. In this way the weight of the hook 1200 is evenly distributed to help maintain the jig 1000 is an upright orientation. In the shown embodiment, the hook is received within a hook holder that is angled from the base. The hook holder is aligned along a same vertical plane as the hook 1200 to maintain the balance of the jig 1000, as well as to align the hook for engaging with a fish when lured by the feather. In one embodiment, the feather is also aligned along the same vertical plane, wherein the vertical plane extends perpendicular from the flat lower surface.

In one embodiment, the hook 1200 is removable from the base and interchanable with a similar hook. This provides a user with the ability to replace a damaged hook. In one embodiment, the hook is secured via a fastener, such as a friction fit, adhesive, latch, and the like to the base.

In the illustrated embodiment, an eyelet 1300 extends from a front side 1150 of the weighted body 1100 and is configured to receive a fishing line therethrough. The eyelet 1300 is positioned on the front side 1150 of the weighted body 1100 to allow the hook to maintain a front facing position as the jig 1000 is dragged in the water by the fishing line. In the illustrated embodiment, the hook 1200 and the eyelet 1300 are aligned on a same vertical plane that bisects the weighted body 1100.

In the illustrated embodiment, the feather tailed stand-up jig 1000 comprises a tail 1400 that extends from the rear side 1140 of the weighted body 1100 and forms a rearmost side of the feather tailed stand-up jig 1000. The tail 1400 comprises a feathered tail configured to mimic the appearance of aquatic organisms as the jig 1000 is moved through the water. In some embodiments, the tail 1400 comprises a single feathered tail (as seen in FIG. 1), wherein other embodiments the tail 1400 comprises a plurality of feathered tails (as seen in FIG. 2). In the illustrated embodiment, each tail 1400 extends directly from the upper surface of the weighted body 1100. In some embodiments, the tail 1400 extends from a recess or aperture 1410 formed within the weighted body 1100.

In the illustrated embodiment, each feathered tail comprises a vane 1420 having both a plurality of barbs 1430 and afterfeathers 1440. The barbs and afterfeathers each comprise a different amount of rigidity, allowing different patterns of movement as the jig 1000 is moved through water. The barbs 1430 are more rigid than the afterfeathers 1440. In other embodiments, each feathered tail comprises barbs having the same rigidity, wherein alternate embodiments the feathered tail is composed entirely of softer afterfeathers.

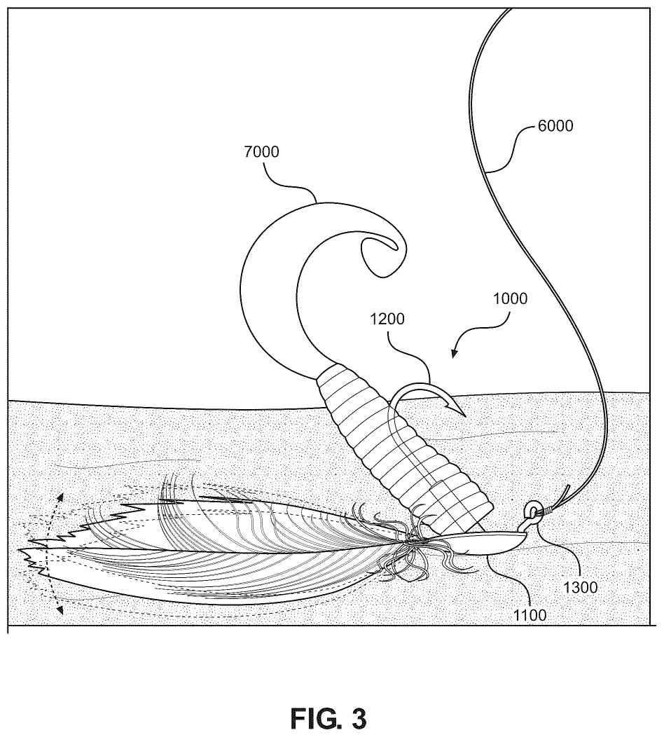

Referring now to FIG. 3, there is shown a perspective view of an embodiment of the feather tailed stand-up jig in use. In operation, a fishing line 6000 is secured to the feather tailed stand-up jig 1000 via the eyelet 1300. Bait 7000, live or manufactured, is secured to the hook 1200. The bait can then be swam, bottom bounced or pulled through weeds to lure fish. The feathered tail provides movement to attract fish, in addition to any bait secured to the hook.

In some embodiments, the tail 1400 is movable or pivotable to allow a user to selectively angle the feathered tail. In this way, the tail 1400 is able to move through the water in different configurations to attract different types of fish.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A feather tailed stand-up jig, comprising:
a weighted body having a proximal end and a distal end;
a hook securely attached to the proximal end of the weighted body, wherein the hook comprises a barb and a shank;
wherein the hook is oriented in an upward-facing position when the weighted body is resting on a bottom of a body of water, such that the barb of the hook is positioned above the bottom;
wherein the weighted body comprises a flat lower surface;
an eyelet extending from a front side of the weighted body and configured to receive a fishing line therethrough;
a tail extending from a rear side of the weighted body, wherein the tail forms a rearmost side of the feather tailed stand-up jig.

2. The feather tailed stand-up jig of claim 1, wherein the hook and the eyelet are aligned on a same vertical plane bisecting the weighted body.

3. The feather tailed stand-up jig of claim 1, wherein the shank extends towards the rear side of the weighted body.

4. The feather tailed stand-up jig of claim 1, wherein the weighted body comprises an elongated shape.

5. The feather tailed stand-up jig of claim 1, wherein the tail comprises a feather extending outwardly from the weighted body.

6. The feather tailed stand-up jig of claim 5, wherein the tail comprises a plurality of feathers, wherein the tail is configured to mimic aquatic organisms.

7. The feather tailed stand-up jig of claim 5, wherein the tail is pivotally secured to the weighted body to allow the tail pivot along a horizontal and a vertical axis.

8. A feather tailed stand-up jig, consisting of:
A weighted body having a proximal end and a distal end;
a hook securely attached to the proximal end of the weighted body, wherein the hook comprises a barb and a shank;
wherein the hook is oriented in an upward-facing position when the weighted body is resting on a bottom of a body of water, such that the barb of the hook is positioned above the bottom;
wherein the weighted body comprises a flat lower surface;
an eyelet extending from a front side of the weighted body and configured to receive a fishing line therethrough;
a tail extending from a rear side of the weighted body, wherein the tail forms a rearmost side of the feather tailed stand-up jig.
